(19) United States
(12) Patent Application Publication
(10) Pub. No.: US 2009/0119176 A1
(43) Pub. Date: May 7, 2009

(54) Methods and systems for interchange adjustment

(75) Inventor: William Johnson, Marietta, GA (US)

Correspondence Address: KING & SPALDING LLP (CITI CUSTOMER NUMBER);ATTN: GEORGE T. MARCOU, 1700 PENNSYLVANIA AVENUE, NW, SUITE 200, WASHINGTON, DC, 20006, US

(73) Assignee: CITICORP CREDIT SERVICES, INC.

(21) Appl. No.: 12/289,674

(22) Filed: Oct. 31, 2008

Related U.S. Application Data
(60) Provisional application No. 60/996,133, filed on Nov. 2, 2007.

(51) Int. Cl. G06Q 20/00; G06Q 30/00; G06Q 10/00; G06Q 40/00

(52) U.S. Cl. 705/14; 705/400; 705/41; 705/34; 235/379

(57) ABSTRACT

A computer-implemented method and system for interchange adjustment as it relates to private label accounts involves enabling a private label card account with a partner by a card issuer through a card association network with a special program fee that is greater or less than a pre-determined interchange fee established by the card association; issuing a private label card by the card issuer to a cardholder and establishing an associated private label card account for the cardholder; and receiving data for a transaction by a processing system of the card association. The card association processing system calculates and collects the established interchange fee on behalf of the card issuer and sends the transaction data to the card issuer, which calculates a difference between the interchange fee and the special program fee and sends an adjustment back seamlessly through the card association network for credit or debit to an account of the partner.

### PRIORITY APPLICATION

This application claims the benefit of U.S. Provisional Application No. 60/996,133 filed Nov. 2, 2007, entitled “METHODS AND SYSTEMS FOR INTERCHANGE ADJUSTMENT”, which is incorporated herein by this reference.

### FIELD OF THE INVENTION

The present invention relates generally to the field of transaction cards, and more particularly to methods and systems for interchange adjustment as it relates to private label accounts in which a card issuer, such as a bank, enters a special economic arrangement with a partner to facilitate sales for the partner and value propositions back to their customers who are the card issuer's cardholders.

### BACKGROUND OF THE INVENTION

In a typical credit card transaction, a consumer uses a plastic card issued by a card issuer, such as a bank, to pay a merchant for a purchase. The merchant receives settlement and payment services from an acquirer, such as the merchant's bank, in return for payment of a merchant service charge. The acquirer receives settlement and credit risk services from the card issuer in return for an interchange fee established by a card association, such as VISA® or MASTERCARD®, which processes transactions with the card through an association processing system. In turn, the acquirer passes the cost of the interchange fee on to the merchant as a major portion of the merchant service fee. The interchange fee schedules established by the card associations are typically followed by all parties.

### SUMMARY OF THE INVENTION

Embodiments of the present invention provide methods and systems for interchange adjustment functionality as it relates to private label accounts with respect to which a card issuer, such as a bank, has a relationship with a partner, such as a merchant or other type of external entity, and enters a special economic arrangement with the partner to facilitate sales for the partner and value propositions back to their customers who are the card issuer's cardholders.

Embodiments of the invention employ computer hardware and software, including, without limitation, instructions embodied in computer program code encoded on machine readable medium for execution in a processor and memory coupled to the processor, to provide methods and systems for interchange adjustment in which a card issuer enters an economic arrangement with a partner for a special program fee in connection with a private label card enabled through the card association network that is either greater than or less than the interchange fee established by the card association. When a card issued by the card issuer is swiped through the partner's terminal at the point of sale, the transaction data goes through an acquiring financial institution and the card association's processing system, where the interchange fee established by the card association is calculated and collected on behalf of the card issuer.

Thereafter, when the transaction data reaches the card issuer, if the card issuer identifies the transaction as falling within the special economic arrangement with the partner, the difference between the interchange fee established by the card association and the special program fee is calculated by the card issuer. The card issuing financial institution then sends an adjustment of the calculated amount back seamlessly through the association network to the private label account partner and either credits or debits the partner's account at the partner's acquiring financial institution. The card issuer may also send a special report on the backend to its partner that includes a transaction amount, the initial interchange fee charged according to the card association schedule, the difference to be charged or debited by adjustment according to special arrangements with the partner, and the actual charge or debit.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

FIG. 1 is a schematic diagram that illustrates an overview example of key components and the flow of information between key components of a system for interchange adjustment for embodiments of the invention; and

FIG. 2 is a flow chart that illustrates an example of the process of interchange adjustment for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used on another embodiment to yield a still further embodiment. Thus, it is intended that the present invention cover such modifications and variations that come within the scope of the invention.

Embodiments of the invention involve, for example, an interchange adjustment functionality as it relates to private label accounts with respect to which a card issuer, such as a bank, has a relationship with a partner, such as a merchant or other type of external entity, and enters a special economic arrangement with the partner to facilitate sales for the partner and value propositions back to their customers who are the card issuer's cardholders. In embodiments of the invention, the card issuer enables its private label cards through the card association networks, such as the VISA® and MASTERCARD® networks. The association networks impose a standard schedule of card issuer interchange fees to which they hold the members of their association. Since the private label cards are processed through the association network but are not association cards, the card issuer is able to negotiate economics directly with its partners to facilitate some of that value, which may be less than what is standard for an association card or greater than what is standard for an association card.

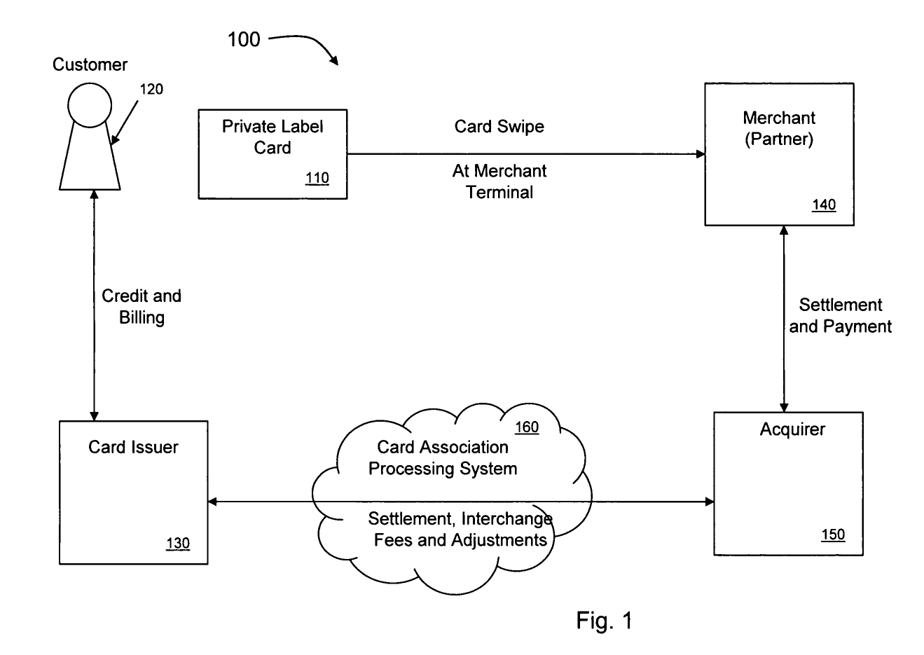

FIG. 1 is a schematic diagram that illustrates an overview example of key components and the flow of information between key components of a system for interchange adjustment for embodiments of the invention. Referring to FIG. 1, components of the system 100 for embodiments of the invention include, for example, a private label transaction card 110 issued to a customer 120 by a card issuer 130 usable in transactions via a POS terminal or similar device (not illustrated) of a merchant-partner 140. Other components include, for example, an acquirer 150 that processes the merchant's credit card authorizations and payments and forwards the data to a card association's processing system 160, which in turn communicates with a processing platform of the card issuer 130.

It is to be understood that references herein to components, such as the issuer 130, the merchant-partner 140, the acquirer 150, the card association's processing system 160, and the issuer's processing platform include, without limitation, processors coupled to memory and to other processors likewise coupled to memory via computer networks, as well as computer program products stored in machine readable media and executing in such processors and memory.

Embodiments of the invention involve, for example, providing the ability to transact a sale over the association network 160 back to the card issuing financial institution 130 for which the card issuer 130 receives the issuer interchange fee portion of the transaction that is established by the card association and thereafter, on the backend, calculating the difference between the standard association interchange fee and the card issuer's special contracted economics and sending that calculated amount back through the association network to the private label account partner as an adjustment.

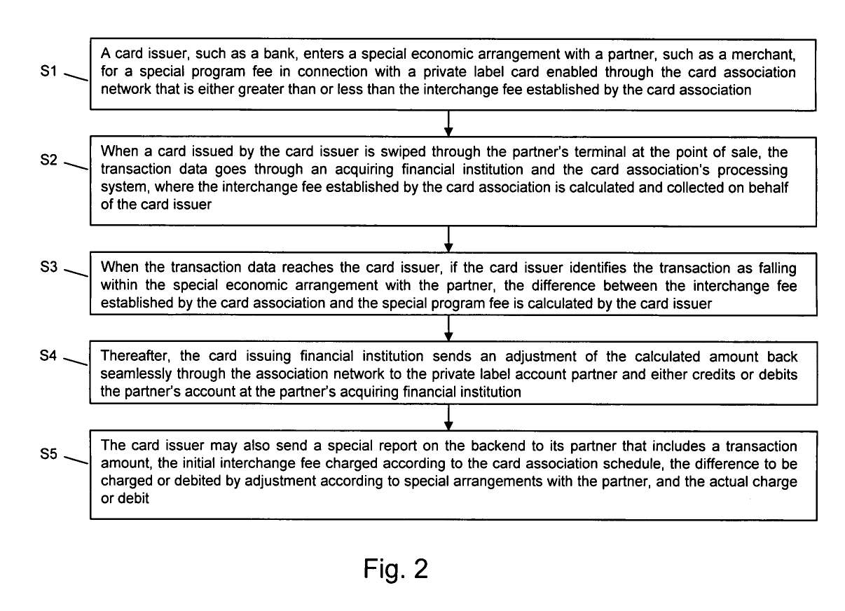

FIG. 2 is a flow chart that illustrates an example of the process of interchange adjustment for embodiments of the invention. The method is organized as a sequence of modules or steps in the flow chart. However, it is to be understood that these and modules associated with other methods described herein may be rendered for parallel execution or into different sequences of modules.

Referring to FIG. 2, at S1, the card issuer 130, such as a bank, enters a special economic arrangement with a partner, such as merchant 140, for a special program fee in connection with a private label card 110 enabled through the card association network 160 that is either greater than or less than the interchange fee established by the card association. At S2, when the card 110 issued by the card issuer 130 to a customer 120 is swiped through the terminal at the point of sale of the partner 140, the transaction data goes through the acquiring financial institution 150 and the card association's processing system 160, where the interchange fee established by the card association is calculated and collected on behalf of the card issuer 130.

Referring further to FIG. 2, at S3, when the transaction data reaches the card issuer 130, if the card issuer 130 identifies the transaction as falling within the special economic arrangement with the partner 140, the difference between the interchange fee established by the card association and the special program fee is calculated by the card issuer 130. Thereafter, at S4, the card issuing financial institution 130 sends an adjustment of the calculated amount back seamlessly through the association network 160 to the private label account partner 140 and either credits or debits the partner's account at the partner's acquiring financial institution 150. At S5, the card issuer 130 may also send a special report on the backend to its partner 140 that includes a transaction amount, the initial interchange fee charged according to the card association schedule, the difference to be charged or debited by adjustment according to special arrangements with the partner 140, and the actual charge or debit.

An aspect of embodiments of the invention involves, for example, contracting with the private label account partner 140 in order for the partner to offer credit card payment terms to its customers, such as an 18 months-same-as-cash deal for its customers on transactions within a pre-determined window of time. In this aspect, the card issuing financial institution 130 enters an agreement with its partner 140 for such special economics and again on the backend, calculates the difference between the standard association interchange fee and the card issuer's special contracted economics and sends that calculated amount back seamlessly through the association network 160 to the private label account partner 140 and either credits or debits the partner's account at the acquirer financial institution 150 with virtually no customization or special requirements.

For an example of the process for embodiments of the invention, assume that on average when an association plastic card, such as card 110, is presented in the store of a merchant, such as merchant-partner 140, and swiped through the merchant's POS terminal, the interchange fee charge is approximately 170 basis points to the sale (i.e., 1.7% of the sale). Assume also, that the card issuing financial institution 130 may charge a premium of 400 basis points (i.e. 4.0%) for an 18 months-same-as-cash-program. Thus, according to embodiments of the invention, when the card 110 is swiped through the merchant's terminal at the point of sale, the transaction data goes through the acquiring financial institution 150 and the card association's processing system 160, where the interchange fee is calculated according to the card association's schedule of interchange fees for the particular transaction, and the 170 basis points to the sale (i.e., 1.7. % of the sale) is collected on behalf of the card issuing financial institution 130.

In the foregoing example for embodiments of the invention, the card issuing financial institution 130 receives a credit for the 170 basis points to the transaction (i.e., 1.7% of the sale amount) and determines that the particular transaction falls within the 18 months-same-as-cash program for which the premium charge is 400 basis points (i.e. 4.0% of the sale), leaving a difference or delta of 230 basis points to be collected from the merchant's account. Accordingly, the card issuing financial institution 130 sends an adjustment for collection of the 230 basis points delta through the card association system 160 to debit the merchant's account with the acquiring financial institution 150 by that amount to fulfill the private relationship and agreement between the card issuing financial institution 130 and the merchant 140.

Thus, in embodiments of the invention, while the basic interchange fee established by the card association in the example is 170 basis points, the agreement between the card issuing association 130 and its partner, the merchant 140, for the deferred payment program (i.e., the 18 months-same-as-cash program), is a premium charge of 400 basis points. When the card issuing institution 130 identifies a transaction as falling within the deferred payment program, the difference of 230 basis points goes to the card issuing financial institution 130. In order to accomplish that, the card issuing financial institution 130 sends an adjustment or a debit for the 230 basis point amount through the card association system 160 to the merchant's account with the acquiring bank 150.

An alternative aspect of embodiments of the invention involves an agreement between the card issuing financial institution 130 and its partner 140 for a special consideration rather than a premium charge to the partner 140. For an example, on standard revolving transactions, the card issuing financial institution 130 might say to the merchant 140 ‘If you accept our card products in your store in the month of June, we will give you special consideration, i.e. while the card association interchange fee is 170 basis points, we will charge you only 50 basis points’. In this example, when the card 110 is swiped through the merchant's terminal, the transaction data goes through the acquiring financial institution 150 and the card association's processing system 160, where the 170 basis point interchange fee is likewise calculated and collected on behalf of the card issuing financial institution 130. Thereafter, when the card issuing institution 130 identifies a transaction as falling within the special consideration agreement with the merchant 140, the card issuing financial institution 130 sends back an adjustment or credit for the difference of 120 basis points through the card association system 160 to the merchant's account with the acquiring bank 150.

As previously noted, interchange fees are typically driven by the card associations which establish the schedules of interchange fees to which all parties adhere. In embodiments of the invention, certain of the parties go beyond the established practices, for example, with special arrangements and contracts between the card issuing financial institution and its partners. The economies of those special arrangements are then moved through the standard channels without requiring any additional development, such as transferring funds via Automated Clearing House (“ACH”) or wiring funds outside the standard and pre-existing card association channels and processes.

An additional aspect of embodiments of the invention involves special backend reporting by the card issuing financial association 130 to its partner 140 that includes, for example, a transaction amount, the initial interchange fee charged according to the card association schedule, the difference to be charged or debited by adjustment according to special arrangements with the partner 140, and the actual charge or debit amount for the adjustment.

According to embodiments of the invention, the adjusted discount that will be passed back to or collected from the merchant 140 through the interchange 160 is calculated and determined by sending out a message in a proprietary format, such as the card association format. Field definitions for the proprietary message format include, for example, a reason code and message text. The reason code indicates, for example, an adjustment for a promotional transaction, and the message text tells the acquirer 150, for example, that it is receiving an adjustment for a specific merchant. Other fields are provided, some of which may be required and some of which may not be required.

In embodiments of the invention, in sales transactions, if the adjusted discount calculation is a negative amount, the retailer 140 receives a credit, and if the adjusted discount calculation is a positive amount, the retailer 140 is debited. In return transactions, if the adjusted discount calculation is a negative amount, the retailer's account is debited, and if the adjusted discount calculation is a positive amount, the retailer's account is credited.

The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method for interchange adjustment as it relates to private label accounts, comprising:
enabling a private label card account with a partner by a card issuer through a card association network with a special program fee that is either greater than or less than a pre-determined interchange fee established by the card association for members of the card association;
issuing a private label card by the card issuer to a cardholder and establishing an associated private label card account for the cardholder;
receiving data for a transaction entered at the partner's transaction terminal having a card reader through which the transaction card is swiped in connection with the transaction, the transaction data being received by a processing system of the card association via an acquiring financial institution of the partner;
calculating and collecting the established interchange fee for the transaction by the card association processing system on behalf of the card issuer and sending the transaction data to the card issuer;
calculating a difference between the interchange fee established by the card association and the special program fee by the card issuer if the transaction is identified by the card issuer as falling within the private label card account enabled with the partner; and
sending an adjustment of an amount of the calculated difference back seamlessly through the card association network for credit or debit to an account of the partner at the partner's acquiring financial institution.

2. The method of claim 1, wherein enabling the private label card account with the partner further comprises entering a pre-defined economic arrangement by the card issuer with the partner for the special program fee in connection with enabling the private label card through the card association network.

3. The method of claim 1, wherein enabling the private label card account through the card association network with the special program fee further comprises enabling the private label card account with a special program fee that is greater than the pre-determined interchange fee established by the card association.

4. The method of claim 3, wherein enabling the private label card account with a special program fee that is greater than the pre-determined interchange fee established by the card association further comprises enabling the private label card account with a special program premium fee for a deferred payment program.

5. The method of claim 1, wherein enabling the private label card account through the card association network with the special program fee further comprises enabling the private label card account with a special program fee that is less than the pre-determined interchange fee established by the card association.

6. The method of claim 5, wherein enabling the private label card account with a special program fee that is less than the pre-determined interchange fee established by the card association further comprises enabling the private label card account with a special consideration program fee for an incentive for a private label card acceptance program.

7. The method of claim 1, wherein sending the adjustment of the amount of the calculated difference back through the card association network further comprises sending the adjustment of the amount of the calculated difference for credit to the account of the partner at the partner's acquiring financial institution.

8. The method of claim 1, wherein sending the adjustment of the amount of the calculated difference back through the card association network further comprises sending the adjustment of the amount of the calculated difference for debit to the account of the partner at the partner's acquiring financial institution.

9. The method of claim 1, wherein sending the adjustment of the amount of the calculated difference back through the card association network further comprises sending a message in a pre-defined proprietary format with field definitions for at least a reason code specifying a type of adjustment and a message text identifying the partner.

10. The method of claim 9, wherein sending the message in the proprietary format further comprises sending the message in a pre-defined card association format.

11. The method of claim 1, further comprising sending a special report by the card issuer to the partner that includes at least a report of the transaction amount, the card association interchange fee for the transaction, the calculated difference, and the amount of the credit or debit.

12. A computer program product stored in a computer readable media for execution in a processor and memory coupled to the processor for performing a method for interchange adjustment as it relates to private label accounts, comprising:
enabling a private label card account with a partner by a card issuer through a card association network with a special program fee that is either greater than or less than a pre-determined interchange fee established by the card association for members of the card association;
issuing a private label card by the card issuer to a cardholder and establishing an associated private label card account for the cardholder;
receiving data for a transaction entered at the partner's transaction terminal having a card reader through which the transaction card is swiped in connection with the transaction, the transaction data being received by a processing system of the card association via an acquiring financial institution of the partner;
calculating and collecting the established interchange fee for the transaction by the card association processing system on behalf of the card issuer and sending the transaction data to the card issuer;
calculating a difference between the interchange fee established by the card association and the special program fee by the card issuer if the transaction is identified by the card issuer as falling within the private label card account enabled with the partner; and
sending an adjustment of an amount of the calculated difference back seamlessly through card association network for credit or debit to an account of the partner at the partner's acquiring financial institution.

13. A computer system for interchange adjustment as it relates to private label accounts, comprising:
means for enabling a private label card account with a partner by a card issuer through a card association network with a special program fee that is either greater than or less than a pre-determined interchange fee established by the card association for members of the card association;
means for issuing a private label card by the card issuer to a cardholder and establishing an associated private label card account for the cardholder;
a processing system of the card association preprogrammed for receiving via an acquiring financial institution of the partner data for a transaction entered at the partner's transaction terminal having a card reader through which the transaction card is swiped in connection with the transaction;
the processing system of the card association being preprogrammed for calculating and collecting the established interchange fee for the transaction by the card association processing system on behalf of the card issuer and sending the transaction data to the card issuer;
a card issuer processing platform being preprogrammed for calculating a difference between the interchange fee established by the card association and the special program fee if the transaction is identified by the card issuer processing platform as falling within the private label card account enabled with the partner; and
the card issuer processing platform being preprogrammed for sending an adjustment of an amount of the calculated difference back seamlessly through the card association network for credit or debit to an account of the partner at the partner's acquiring financial institution.
